(19) United States
(12) Patent Application Publication
(10) Pub. No.: US 2002/0134503 A1
(43) Pub. Date: Sep. 26, 2002

(54) Silicon wafers bonded to insulator substrates by low viscosity epoxy wicking

(75) Inventors: Keith R. Hussinger, San Carlos, CA (US); Philip B. Cullen, San Ramon, CA (US)

Correspondence Address: NATHAN N KALLMAN, 20900 SARAHILLS DRIVE, SARATOGA, CA, 95070, US

(73) Assignee: AccuCorp Technical Services, Inc.

(21) Appl. No.: 09/812,000

(22) Filed: Mar. 20, 2001

(51) Int. Cl. C09J 1/00

(52) U.S. Cl. 156/331.4; 156/281

(57) ABSTRACT

A process and assembly of a silicon-on-insulator substrate or handle incorporates a low initial viscosity epoxy adhesive having a high cross-linking density. The assembly is formed by distributing the epoxy adhesive at the interstice between a silicon wafer and the handle and heating the assembly so that the epoxy adhesive wicks by capillary action between the silicon wafer and the handle. The heating causes the epoxy adhesive to cross-link so that a strong adhesion is effectuated between the silicon and handle. The simply controllable process affords a high yield at relatively low cost.

### FIELD OF THE INVENTION

This invention relates to a method and assembly of bonding silicon wafers to insulator substrates by low viscosity epoxy adhesive wicking.

### DESCRIPTION OF THE PRIOR ART

Presently known “silicon-on-insulator” (SOI) wafers are generally used as semiconductor substrates. Typically, these substrates consist of a standard crystalline silicon wafer bonded to an insulator substrate, called a “handle, having a very high electrical impedance. This class of semiconductor substrate is in high demand for applications in the integrated circuit industry as well as for new applications in fiber optic telecommunications and “MEMS” or micro-electromechanical systems.

The most common material used for SOI wafers is crystalline silicon which has had an oxide or nitride of silicon applied by one of various methods, such as thermal oxidation or nitridation, chemical vapor deposition or physical vapor deposition. Alternatively, the insulator handle may be made of glass, ceramic, crystalline sapphire or any other material having prescribed thermal or mechanical characteristics. The insulator layer is required for electrical isolation of devices fabricated on the silicon layer, particularly in low power applications. This insulator layer is also used as a hard stop layer in fabrication processes requiring through etching of the silicon layer. Typically this characteristic is employed for MEMS or fiber optic devices. The structure of a silicon wafer, a handle, and an insulator is commonly referred to in the technology as a “wafer stack”.

There are two known methods for bonding a crystalline silicon wafer to an insulator handle. One method is fusion bonding, which uses the low entropy nature of crystals to allow molecular adhesion by simple contact. The other is anodic bonding which relies on applied electrostatic potential to promote adhesion of the wafer and handle once they are in physical contact. Both of these methods suffer from the same inherent problems. One problem is that the surfaces presented for bonding must be very smooth (typical RMS roughness in the nanometer range) and completely free from any particulate contamination. In fact, the particulate contamination density required for successful bonding is usually several orders of magnitude lower than that required for fabrication of devices on a bonded wafer assembly. Another problem is that the bonding process requires high temperatures to move the reaction forward and to anneal out defects in the interface layer. These temperatures may be above 1000 degrees Celsius. In addition, wafer bonding is best carried out under high vacuum conditions to avoid the formation of unbonded zones in the wafer stack due to gas inclusion. All of these problems are exacerbated by the fact that the crystalline silicon layer is usually thinned by mechanical means to a thickness of a few micrometers above the bond layer. Furthermore, if a defectively bonded wafer survives the mechanical thinning process, problems such as delamination may arise at the wafer dicing procedure. Substrate failure after device fabrication adversely affects production so that wafer fabrication becomes costly. In effect, these problems that are experienced during wafer bonding have led to low yield, high cost processes that have constrained the industries dependent upon these products with high materials cost, exceedingly long lead times for substrates and unreliable supplies. Presently, a shortage of SOI wafers exists at a time when there are enormous pressures for inexpensive and reliable sources of SOI wafers. Clearly, there is a great need for SOI wafers that are fabricated to avoid the afore-mentioned problems and that will meet the needs of the wafer fab houses.

### SUMMARY OF THE INVENTION

An object of this invention is to provide a novel method for bonding silicon wafers to an insulator substrate or handle.

Another object of the invention is to provide a novel assembly of silicon-on-insulator substrate (SOI) structures.

According to this invention, a process for bonding silicon wafers to insulator substrates uses a uniformly mixed, low initial viscosity, bisphenal-a epoxy adhesive having a high cross-linking density. The introduction of the epoxy material to the interstice between a silicon wafer and insulator substrate and the physical characteristics of the unlinked epoxy ensures complete wicking, or uniform transport by capillary action, of the adhesive across the entire interface of the wafer and the substrate. The process is implemented by either thermal oxidation, nitridation, chemical vapor deposition (CVD), physical vapor deposition (PVD), ion beam deposition or electron beam evaporation.

### BRIEF DESCRIPTION OF THE DRAWINGS

The invention will be described in greater detail with reference to the drawing in which:

FIG. 1a) is a side view depicting a typical semiconductor wafer;

FIG. 1b) is a side view of an insulator substrate or handle;

FIG. 1c) is a side view showing an unbonded and aligned wafer stack;

FIG. 1d) is a side view of a semiconductor wafer and handle clipped together and bonded with a low viscosity epoxy adhesive by wicking;

FIG. 2a) is a side view depicting a typical semiconductor wafer;

FIG. 2b) is a side view of a wafer formed with a dielectric film;

FIG. 2c) is a side view of an insulator handle;

FIG. 2d) is a side view of an unbonded wafer and handle;

FIG. 2e) is a side view of a wafer stack, including the handle, clips and bonding epoxy.

### DETAILED DESCRIPTION OF THE INVENTION

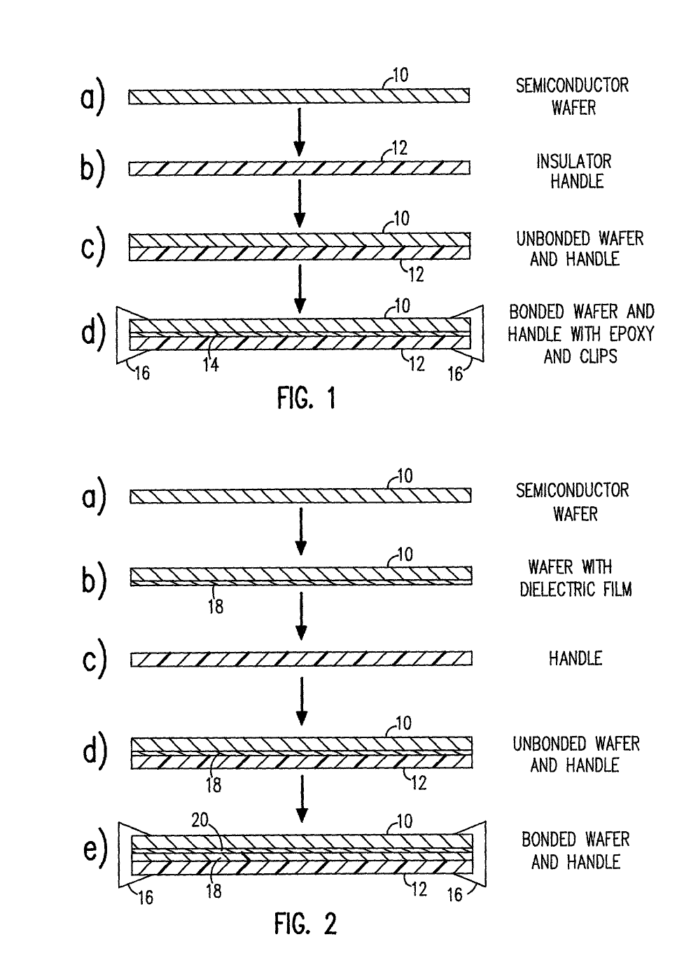

With reference to FIGS. 1a) to 1d), an implementation of the inventive method includes the step of cleaning a semiconductor wafer 10 and handle 12 in a cleaning bath. The wafer 10 is preferably made of a silicon material having at least a four inch diameter and has planar top and bottom surfaces. After removal from the bath, the planar bottom surface of the cleaned wafer 10 and the planar top surface of the handle 12 are aligned in juxtaposition and stacked and maintained in a secure position with lightweight clips 16. The clips 16 hold the edges of the wafer and handle in a fixed aligned position. The secured assembly of the wafer and handle are then placed in an oven which is at a temperature of about 125 degrees Celsius for about one hour. The heated assembly or stack is removed from the oven and then placed in a holder in a vertical orientation. At this point, a uniformly mixed, low initial viscosity, bisphenal-a epoxy adhesive 14 is applied along the upper edge of the stack at the interface between the wafer 10 and handle 12. The application of the unlinked epoxy adhesive 14 to the wafer stack and the physical characteristics of the unlinked epoxy ensures complete wicking, by capillary action and uniform transport of the adhesive, across the planar bottom wafer surface that is in contact with the opposing planar top surface of the handle. As the low viscosity, unlinked polymer adhesive wicks across the interface, it displaces trapped gases from the interstitial void, thus precluding the need for high vacuum processes. The assembly of the wafer and handle with the epoxy applied thereto is returned to the oven. In the oven, the epoxy adhesive 4 wicks along the interstice between the wafer and the handle and flows therebetween to form a uniform epoxy layer across the adjacent opposing surfaces of the wafer and the handle that will serve as a bond between the wafer and the handle. The assembly remains in the oven for at least 4 hours and up to 24 hours to allow cross-linking of the epoxy. After removal from the oven, the joined assembly of the wafer and handle, which are bonded by the cross-linked epoxy, the clips 16 are removed and the wafer stack is ground on the top and the bottom by blanchard grinding to a predetermined thickness.

As an alternative to the use of lightweight clips and an oven for epoxy wicking and curing, the wafers can be placed on a rigid, heated, flat surface member that is maintained at a temperature of about 125 degrees Celsius. The flat surface member is placed within a heat-resistant, flexible, airtight container from which the atmosphere is evacuated. By this method, the bond line is formed with a uniform thickness during the wicking of the epoxy, and the limit of the wicking capability of the epoxy is approached. The wafers are maintained in this environment for about two hours, and then placed in a heated oven which is held at about 125 degrees Celsius for four to twenty-four hours to complete the curing of the low viscosity epoxy.

In another implementation of the novel process, a prepared wafer 10 has a dielectric film 18 formed on its lower polished surface by chemical vapor deposition or other well known deposition methods. The wafer 10 and handle 12 are cleaned in a cleaning bath. The wafer and handle are aligned and stacked together with the dielectric layer 18 facing the upper surface of the handle 12. Lightweight clips 16 hold the edges together. The assembled wafer and handle with the dielectric therebetween are placed in an oven and heated at a temperature of about 125 degrees Celsius for a period of approximately one hour. The heated assembly is removed from the oven, and a low initial viscosity, bisphenyl-a epoxy adhesive 20 is applied along the top edge of the interface between the wafer and the handle, while the assembly is held in a fixed substantially vertical position. The assembly is then returned to the oven wherein the epoxy adhesive wicks along the interface between the wafer and the handle. The assembly is kept in the oven at a temperature of about 125 degrees Celsius for four to twenty-four hours to ensure cross-linking of the epoxy and the bonding of the handle and wafer with the dielectric film 18 therebetween. After removal of the bonded assembly, the clips 16 are removed and the exposed surfaces of the wafer and the handle are ground to a desired thickness by blanchard grinding. The advantage of this second method is that there is no adherence of any of the epoxy polymer to the area of the wafer that is used for device fabrication. In such case, the polymer adhesive is separated from the device wafer by the interlayer dielectric.

By virtue of this invention, an SOI wafer stack is made by utilizing a low viscosity epoxy adhesive polymer, characterized by a high cross-linking density for an adhesion layer, in contrast with the prior art approach of relying on the ability to consistently clean and smooth two surfaces to a prohibitively low tolerance. The process disclosed herein realizes a high-volume, low cost process with a high yield that is repeatedly and controllably achieved. Furthermore, the stress induced in the wafer assembly by the method disclosed herein is very low, having been measured at less than −1×10⁶ Pascals (compressive).

This invention is applicable to all forms of semiconductor device layers including ,but not limited to, silicon, gallium arsenide, cadmium telluride, as well as all forms of insulator handles including, but not limited to, glass, silicon dioxide interlayer dielectric, silicon nitride interlayer dielectric, sapphire, alumina interlayer dielectric, among others. The use of a polymer bonding layer obviates the need for chemically compatible materials for the semiconductor wafer layer and handle. Furthermore, because the bonding method exploits the well understood physical phenomenon of capillary action, as the low initial viscosity, unlinked polymer wicks across the interface, it displaces any trapped gases from the interstitial voids, precluding the need for high vacuum process parameters.

What is claimed is:

1. A method for forming silicon-on-insulator assemblies comprising the steps of:
providing a crystalline silicon wafer having a planar top surface and a planar bottom surface and a diameter of at least four inches;
providing an insulator handle having a planar top surface and a planar bottom surface and surface areas substantially the same as that of said silicon wafer;
cleaning said wafer and said handle in a cleaning bath;
aligning and securing said bottom surface of said wafer and said top surface of said handle in contact with each other thereby forming an assembly with an interface between said wafer and said handle;
heating the assembly of said wafer and handle;
applying a low viscosity epoxy adhesive directly to the inerface between said wafer and handle; and
placing the assembly with the applied epoxy adhesive in a heated oven so that said wafer and handle are bonded by the wicking of the epoxy adhesive which is cross-linked by the heating in the oven, thereby forming a silicon-on-insulator wafer stack.

2. A method as in claim 1, wherein said low viscosity epoxy adhesive is a uniformly mixed, low initial viscosity, bisphenyl-a epoxy adhesive with a high cross-linking density.

3. A method as in claim 1, wherein said step of aligning and positioning includes the holding of said wafer and handle by attaching clips while said wafer and handle are aligned in contact with each other.

4. A method as in claim 3, including the step of positioning said wafer and handle in a vertical position and applying said epoxy adhesive across the top edge of the interface between said wafer and said handle prior to placing said wafer and handle in a heated oven, wherein said epoxy adhesive wicks by capillary action between the interface.

6. A method as in claim 1, including the step of providing a dielectric film to the bottom surface of said wafer prior to positioning said wafer in contact with said handle.

7. A method as in claim 1, including the step of grinding said top surface of said wafer and said bottom surface of said handle of said assembly to a predetermined thickness.

8. A semiconductor-on-insulator handle assembly comprising:
a semiconductor wafer having a diameter of at least four inches and having a planar top surface and a planar bottom surface;
an insulator handle of substantially the same area as that of said wafer and having a top surface and a bottom surface; and
an epoxy adhesive distributed uniformly by wicking between the planar bottom surface of said wafer and the planar top surface of said handle.

9. An assembly as in claim 8, wherein said wafer is made of a material selected from the group of silicon, gallium arsenide and cadmium telleride.

10. An assembly as in claim 8, wherein said handle is an insulator substrate material selected from the group of glass, silicon dioxide, silicon nitride, sapphire and alumina.

11. An assembly as in claim 8, wherein said epoxy adhesive is a low initial viscosity, bisphenal-a epoxy adhesive characterized by a high cross-linking density.

12. An assembly as in claim 8, including a dielectric film disposed between the bottom surface of said wafer and said epoxy adhesive
